(19) United States
(12) Patent Application Publication
(10) Pub. No.: US 2015/0199236 A1
(43) Pub. Date: Jul. 16, 2015

(54) MULTI-LEVEL DISK FAILURE PROTECTION

(71) Applicant: INFINIDAT LTD., Herzliya (IL)

(72) Inventors: Mike Selivanov, Hod-Hasharon (IL); Alexander Goldberg, Rehovot (IL); Cyril Plisko, Petah Tikvah (IL)

(73) Assignee: INFINIDAT LTD., Herzliya (IL)

(21) Appl. No.: 14/153,095

(22) Filed: Jan. 13, 2014

(51) Int. Cl. G06F 11/10

(52) U.S. Cl. CPC G06F 11/1096; G06F 2211/1009

(57) ABSTRACT

According to an embodiment of the invention there may be provided a method for multi-level disk failure protection, the method may include: calculating first parity information by processing a first data entity that is cached in a cache memory of a storage system thereby providing a first level of disk failure protection; destaging the first data entity and the first parity information to first physical addresses mapped to multiple disks; calculating extra parity information by processing the first data entity, wherein a combination of the first and extra parity information provides an extra level of disk failure protection that exceeds the first level of disk failure protection; and destaging the extra parity information to at least one second physical address that differ from the first physical addresses, the at least one second physical address are included in a spare physical memory space that is not allocated, at a time of the destaging of the extra parity information, for storing data.

### BACKGROUND

A disk storage or disc storage is a general category of storage mechanisms, in which data are digitally recorded by various electronic, magnetic, optical, or mechanical methods on a surface layer deposited of one or more planar, round and rotating disks (or discs) (also referred to as the media).

A disk (also referred to as a disk drive) is a device implementing such a storage mechanism with fixed or removable media; with removable media the device is usually distinguished from the media as in compact disc drive and the compact disc.

Notable types are the hard disk drives (HDD) containing a non-removable disk, the floppy disk drive (FDD) and its removable floppy disk, and various optical disc drives and associated optical disc media (www.wikipedia.org).

RAID (redundant array of independent disks) is a storage technology that combines multiple disks into a logical unit. Data is distributed across the drives in one of several ways called “RAID levels”, depending on the level of redundancy and performance required (www.wikipedia.org).

RAID is used as an umbrella term for computer data storage schemes that can divide and replicate data among multiple physical drives: RAID is an example of storage virtualization and the array can be accessed by the operating system as one single drive.

The different schemes or architectures are named by the word RAID followed by a number (e.g., RAID 0, RAID 1, RAID 2, RAID 3, RAID 4, RAID 5, RAID 6 and RAID 10). Each scheme provides a different balance between the key goals: reliability and availability, performance and capacity. RAID levels greater than RAID 0 provide protection against unrecoverable (sector) read errors, as well as whole disk failure.

A number of standard schemes have evolved which are referred to as levels. There were five RAID levels originally conceived, but many more variations have evolved, notably several nested levels and many non-standard levels (mostly proprietary). RAID levels and their associated data formats are standardized by the Storage Networking Industry Association (SNIA) in the Common RAID Disk Drive Format (DDF) standard.

RAID 5, 6 and 10 levels are commonly used in the industry.

RAID 5 (block-level striping with distributed parity) distributes parity along with the data and requires all drives but one to be present to operate. The array is not destroyed by a single drive failure. Upon drive failure, any subsequent reads can be calculated from the distributed parity such that the drive failure is masked from the end user. RAID 5 requires at least three disks.

RAID 6 (block-level striping with double distributed parity) provides fault tolerance up to two failed drives. This makes larger RAID groups more practical, especially for high-availability systems. This becomes increasingly important as large-capacity drives lengthen the time needed to recover from the failure of a single drive. Like RAID 5, a single drive failure results in reduced performance of the entire array until the failed drive has been replaced and the associated data rebuilt.

In RAID 10 (often referred to as RAID 1+0) (mirroring and striping), data are written in stripes across primary disks that have been mirrored to the secondary disks.

Modern storage systems may include large numbers of disk drives. There is a growing need to provide reliable and efficient storage systems

RAID 5 calculates a single parity block for multiple data blocks.

The parity block is calculated as the XOR of all data blocks. RAID 5 provides an ability to recover from a single disk failure. The reconstruction of a failed disk requires reading all other disks. There is a relatively high risk for a second disk failure during the reconstruction of the failed disk.

RAID 6 calculates a pair of parity blocks for multiple data blocks. Parity blocks are calculated as XOR and Galois field (GF) multiplication of all data blocks.

RAID 6 provides the ability to recover from up to 2 disk failures. The reconstruction failed disks requires reading all other disks. It was believed to have relatively low risk for a third disk to fail during the reconstruction of two failed disks.

There is a growing need to enhance the failure protection level provided to a user of a storage system.

### SUMMARY

According to an embodiment of the invention various methods may be provided and are described in the specification. According to various embodiments of the invention there may be provided a non-transitory computer readable medium that may store instructions for performing any of the methods described in the specification and any steps thereof, including any combinations of same. Additional embodiments of the invention include a storage system arranged to execute any or all of the methods described in the specification above, including any stages—and any combinations of same.

According to an embodiment of the invention there may be provided a method for multi-level disk failure protection, the method may include: calculating first parity information by processing a first data entity that is cached in a cache memory of a storage system thereby providing a first level of disk failure protection; destaging the first data entity and the first parity information to first physical addresses mapped to multiple disks; calculating extra parity information by processing the first data entity, wherein a combination of the first and extra parity information provides an extra level of disk failure protection that exceeds the first level of disk failure protection; and destaging the extra parity information to at least one second physical address that differ from the first physical addresses, the at least one second physical address are included in a spare physical memory space that is not allocated, at a time of the destaging of the extra parity information, for storing data.

The calculating of the first parity information may include applying a first disk failure protection process and wherein the calculating of the extra parity information may include applying a second disk failure protection process that differs from the first disk failure process.

The number of parity units included in the extra parity information may differ from a number of parity units included in the first parity information.

The first level of disk failure protection may be a minimal acceptable level of disk failure protection.

The method may include maintaining parity metadata that associates the extra parity information to the first data entity.

The method may include determining the extra level of protection in response to an availability of physical addresses for storing extra parity units.

The method may include determining the extra level of protection in response to a priority of the first data entity.

The method may include deleting the extra parity information while maintaining the first data entity and the first parity information.

The method may include determining not to calculate the extra parity information in response to a parameter selected out of (a) a parameter of the storage system and (b) a parameter of the first data entity.

The method may include calculating and destaging multiple extra parity information for multiple data entities; calculating and destaging multiple first parity information for the multiple data entities; selecting, in response to a selection criterion, a selected extra parity information to be deleted; and deleting the selected extra parity information; wherein the multiple data entities may include the first data entity.

The selection criterion may be responsive to priorities of different of data entities protected by different extra parity information.

The selection criterion may be responsive to timing of creation of different extra parity information.

The selection criterion may be responsive to locations of physical addresses allocated for storing different extra parity information.

The selection criterion may be responsive to relationships between physical addresses used for storing different data entities and locations of physical addresses allocated for storing different extra parity information.

The multiple first parity information and the multiple data entities comprise a hybrid group, wherein each row of the hybrid group may include a data entity and first parity information of the data entity; wherein first parity information of different rows are distributed among different columns of the hybrid group; wherein each column of the hybrid group is sequentially destaged to a single disk.

The multiple first parity information and the multiple data entities comprise multiple hybrid groups; wherein the multiple extra parity information are stored in the spare physical memory space, wherein the spare physical memory space is not allocated, at a time of the destaging of either one of the destaging of the multiple extra parity information, for storing hybrid groups.

The method may include receiving an indication that one or more disks that included the first physical addresses failed; retrieving, from the first physical addresses and from the at least one second physical address, retrieved data and parity information; and reconstructing the first data entity based upon the retrieved data and parity information.

According to an embodiment of the invention there may be provided a non-transitory computer readable medium that stores instructions that once executed by a computer cause the computer to perform the stages of calculating first parity information by processing a first data entity that is cached in a cache memory of a storage system thereby providing a first level of disk failure protection; destaging the first data entity and the first parity information to first physical addresses mapped to multiple disks; calculating extra parity information by processing the first data entity, wherein a combination of the first and extra parity information provides an extra level of disk failure protection that exceeds the first level of disk failure protection; and destaging the extra parity information to at least one second physical address that differ from the first physical addresses, the at least one second physical address are included in a spare physical memory space that is not allocated, at a time of the destaging of the extra parity information, for storing data.

The calculating of the first parity information may include applying a first disk failure protection process and wherein the calculating of the extra parity information may include applying a second disk failure protection process that differs from the first disk failure process.

The number of parity units included in the extra parity information may differ from a number of parity units included in the first parity information.

The first level of disk failure protection may be a minimal acceptable level of disk failure protection.

The non-transitory computer readable medium may be arranged to store instructions for maintaining parity metadata that associates the extra parity information to the first data entity.

The non-transitory computer readable medium may be arranged to store instructions for determining the extra level of protection in response to an availability of physical addresses for storing extra parity units.

The non-transitory computer readable medium may be arranged to store instructions for determining the extra level of protection in response to a priority of the first data entity.

The non-transitory computer readable medium may be arranged to store instructions for deleting the extra parity information while maintaining the first data entity and the first parity information.

The non-transitory computer readable medium may be arranged to store instructions for determining not to calculate the extra parity information in response to a parameter selected out of (a) a parameter of the storage system and (b) a parameter of the first data entity.

The non-transitory computer readable medium may be arranged to store instructions for calculating and destaging multiple extra parity information for multiple data entities; calculating and destaging multiple first parity information for the multiple data entities; selecting, in response to a selection criterion, a selected extra parity information to be deleted; and deleting the selected extra parity information; wherein the multiple data entities may include the first data entity.

The selection criterion may be responsive to priorities of different of data entities protected by different extra parity information.

The selection criterion may be responsive to timing of creation of different extra parity information.

The selection criterion may be responsive to locations of physical addresses allocated for storing different extra parity information.

The selection criterion may be responsive to relationships between physical addresses used for storing different data entities and locations of physical addresses allocated for storing different extra parity information.

The multiple first parity information and the multiple data entities comprise a hybrid group, wherein each row of the hybrid group may include a data entity and first parity information of the data entity; wherein first parity information of different rows are distributed among different columns of the hybrid group; wherein each column of the hybrid group is sequentially destaged to a single disk.

The multiple first parity information and the multiple data entities comprise multiple hybrid groups; wherein the multiple extra parity information are stored in the spare physical memory space, wherein the spare physical memory space is not allocated, at a time of the destaging of either one of the destaging of the multiple extra parity information, for storing hybrid groups.

The non-transitory computer readable medium may be arranged to store instructions for receiving an indication that one or more disks that included the first physical addresses failed; retrieving, from the first physical addresses and from the at least one second physical address, retrieved data and parity information; and reconstructing the first data entity based upon the retrieved data and parity information.

According to an embodiment of the invention there may be provided a storage system that may be arranged to calculate first parity information by processing a first data entity that is cached in a cache memory of a storage system thereby providing a first level of disk failure protection; destage the first data entity and the first parity information to first physical addresses mapped to multiple disks; calculate extra parity information by processing the first data entity, wherein a combination of the first and extra parity information provides an extra level of disk failure protection that exceeds the first level of disk failure protection; and destage the extra parity information to at least one second physical address that differ from the first physical addresses, the at least one second physical address are included in a spare physical memory space that is not allocated, at a time of the destaging of the extra parity information, for storing data.

The calculating of the first parity information may include applying a first disk failure protection process and wherein the calculating of the extra parity information may include applying a second disk failure protection process that differs from the first disk failure process.

The number of parity units included in the extra parity information may differ from a number of parity units included in the first parity information.

The first level of disk failure protection may be a minimal acceptable level of disk failure protection.

The storage device may be arranged to maintain parity metadata that associates the extra parity information to the first data entity.

The storage device may be arranged to determine the extra level of protection in response to an availability of physical addresses for storing extra parity units.

The storage device may be arranged to determine the extra level of protection in response to a priority of the first data entity.

The storage device may be arranged to delete the extra parity information while maintaining the first data entity and the first parity information.

The storage device may be arranged to determine not to calculate the extra parity information in response to a parameter selected out of (a) a parameter of the storage system and (b) a parameter of the first data entity.

The storage device may be arranged to calculate and destaging multiple extra parity information for multiple data entities; calculate and destage multiple first parity information for the multiple data entities; select, in response to a selection criterion, a selected extra parity information to be deleted; and delete the selected extra parity information; wherein the multiple data entities may include the first data entity.

The selection criterion may be responsive to priorities of different of data entities protected by different extra parity information.

The selection criterion may be responsive to timing of creation of different extra parity information.

The selection criterion may be responsive to locations of physical addresses allocated for storing different extra parity information.

The selection criterion may be responsive to relationships between physical addresses used for storing different data entities and locations of physical addresses allocated for storing different extra parity information.

The multiple first parity information and the multiple data entities comprise a hybrid group, wherein each row of the hybrid group may include a data entity and first parity information of the data entity; wherein first parity information of different rows are distributed among different columns of the hybrid group; wherein each column of the hybrid group is sequentially destaged to a single disk.

The multiple first parity information and the multiple data entities comprise multiple hybrid groups; wherein the multiple extra parity information are stored in the spare physical memory space, wherein the spare physical memory space is not allocated, at a time of the destaging of either one of the destaging of the multiple extra parity information, for storing hybrid groups.

The storage device may be arranged to receive an indication that one or more disks that included the first physical addresses failed; retrieve, from the first physical addresses and from the at least one second physical address, retrieved data and parity information; and reconstruct the first data entity based upon the retrieved data and parity information.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a method according to an embodiment of the invention;

FIG. 2 illustrates a method according to an embodiment of the invention;

FIG. 3 illustrates a method according to an embodiment of the invention;

FIG. 4 illustrates cached data units, first parity information and extra parity information according to an embodiment of the invention;

FIG. 5 illustrates a hybrid group of data units and first parity units according to an embodiment of the invention;

FIG. 6 illustrates a writing of a hybrid group to disks of eight disk units according to an embodiment of the invention;

FIG. 7 illustrates an allocation of a physical memory space to hybrid groups and to extra parity information according to an embodiment of the invention; and

FIG. 8 illustrates a system according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The term “protection” refers to protection against disk failures.

A storage system can guarantee a first level of protection. This first level of protection can also be referred to a guaranteed level of protection.

There is provided a multi-level failure protection scheme that provides an extra level of protection.

This extra level of protection requires calculating extra parity information and storing the extra parity information in a free memory space that is not allocated for storing user data and also for storing parity information required for supporting the guaranteed level of protection. The free memory space may include multiple physical addresses that may be continuous or non-continuous. The free memory space may include multiple sets of continuous or non-continuous physical addresses. The free memory space may be mapped to one or multiple disks.

The free memory space may be a memory space that is not leased or rented to a user, may be a memory space that is currently not used (for any reason) by a user but may be eventually used by a user.

The extra parity information may be deleted (even without being used) as the free memory space may be allocated to other purposes. In this sense the extra parity information can be reviewed as temporary as its usage for failure recovery is not guaranteed or mandatory.

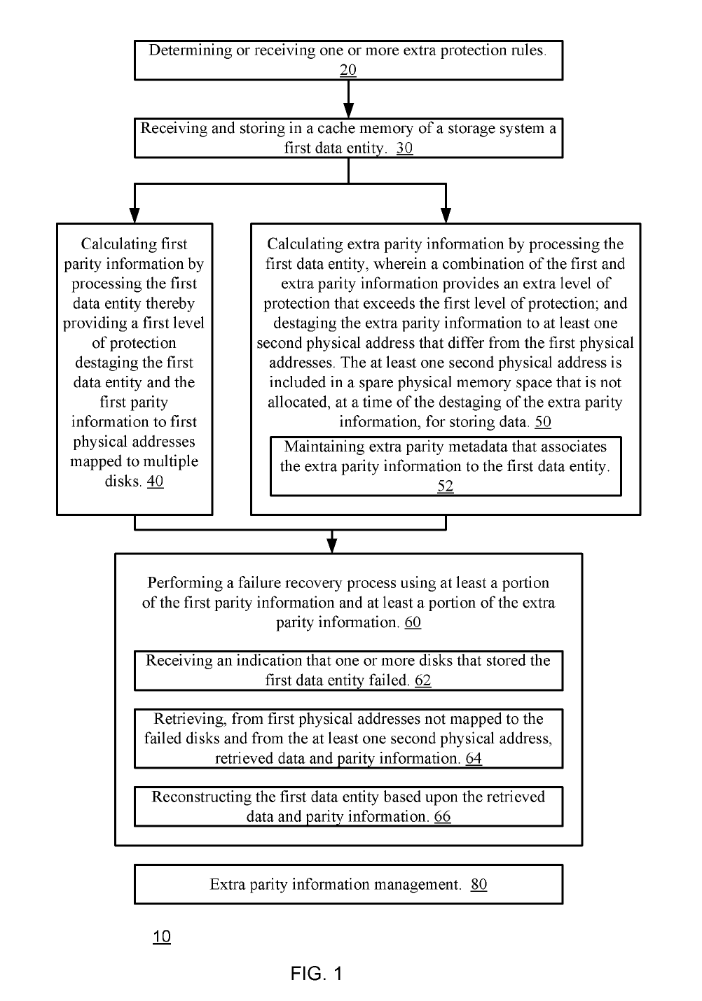

FIG. 1 illustrates a method 10 for multi-level protection, according to an embodiment of the invention.

Method 10 starts by stage 20. Stage 20 may be followed by stage 30. Stage 30 may be followed by stages 40 and 50.

Stage 20 may include determining or receiving one or more extra protection rules.

The one or more extra protection rules may define when to calculate extra protection parity information, when not to calculate extra protection parity information, what extra level of protection should be achieved by the extra protection parity information and the like.

The one or more extra protection rules may link between the extra protection to be provided (if any) and the data entity that should be protected, the availability of spare memory space for storing the extra protection parity information, a load of the storage system or a timing of the creation of the extra protection parity information, and the like.

The one or more extra protection rules may determine that data from different users, computers, or applications should receive the same or different protection.

The one or more extra protection rules may determine that data entities received at different times should receive the same or different protection.

The one or more extra protection rules may define the same kind of calculation of extra parity information for each destaged data entity or may differentiate between one destaged data entity to another.

Stage 30 may include receiving and storing in a cache memory of a storage system a first data entity. The first data entity may be of various sizes and may include multiple bytes.

The first data entity may include multiple data units. A data unit may include multiple bits, one or more bytes, one or more kilobytes and more.

Stage 40 may include (a) calculating first parity information by processing the first data entity thereby providing a first level of protection and (b) destaging the first data entity and the first parity information to first physical addresses mapped to multiple disks.

Stage 50 may include (a) calculating extra parity information by processing the first data entity, wherein a combination of the first and extra parity information provides an extra level of protection that exceeds the first level of protection, for example, the extra level of protection can support more concurrent disk failures than the first level of protection, e.g., if the first level of protection can support up to two concurrently failed disks, the extra level of protection can support three or more concurrently failed disks; and (b) destaging the extra parity information to at least one second physical address that differ from the first physical addresses.

The at least one second physical address is included in a spare physical memory space that is not allocated, at a time of the destaging of the extra parity information, for storing data.

It is noted that method 10 may include a stage (not shown) of determining whether to calculate the extra parity information or not. The method may include skipping stage 50 if determining not to calculate the extra parity information.

Additionally or alternatively, method 10 may include a stage (now shown) of determining the manner in which the extra parity information is calculated—the required level of protection to be provided, a disk failure protection process to be applied and the like (Reed Solomon, different RAID level compliant algorithms). Either one of these stages may be responsive to one or more extra protection rules.

The first level and extra parity information may include parity units.

Stage 40 may include applying a first protection process. Stage 50 may include applying a second protection process that differs from the first process process.

The first and second protection processes may be compliant to different RAID levels, may differ from each other by the number of parity units they provide, may differ by a selection of data units to be used for calculating each parity unit, and the like.

Stage 50 may include maintaining (52) extra parity metadata that associates the extra parity information with the first data entity. The extra parity metadata may be included in a same data structure that includes mapping information about the locations of the first data entity and of the first parity information or be included in a separate data structure.

Stage 50 may be followed by stage 60 performing a failure recovery process using at least a portion of the first parity information and at least a portion of the extra parity information.

Stage 60 may include:
A. Stage 62 of receiving an indication that one or more disks that stored the first data entity failed.
B. Stage 64 of retrieving, from first physical addresses not mapped to the failed disks and from the at least one second physical address, retrieved data and parity information.
C. Stage 66 of reconstructing the first data entity based upon the retrieved data and parity information.

Method 10 may also include stage 80 of extra parity information management. This stage may involve deleting all or some of the extra parity information. The deletion may be responsive to a parameter of the storage system, and/or a parameter of data that is being protected and/or a parameter of the extra parity information.

If, for example, the free storage space stores multiple extra parity information for multiple data entities then stage 80 may include selecting which extra parity information should be deleted.

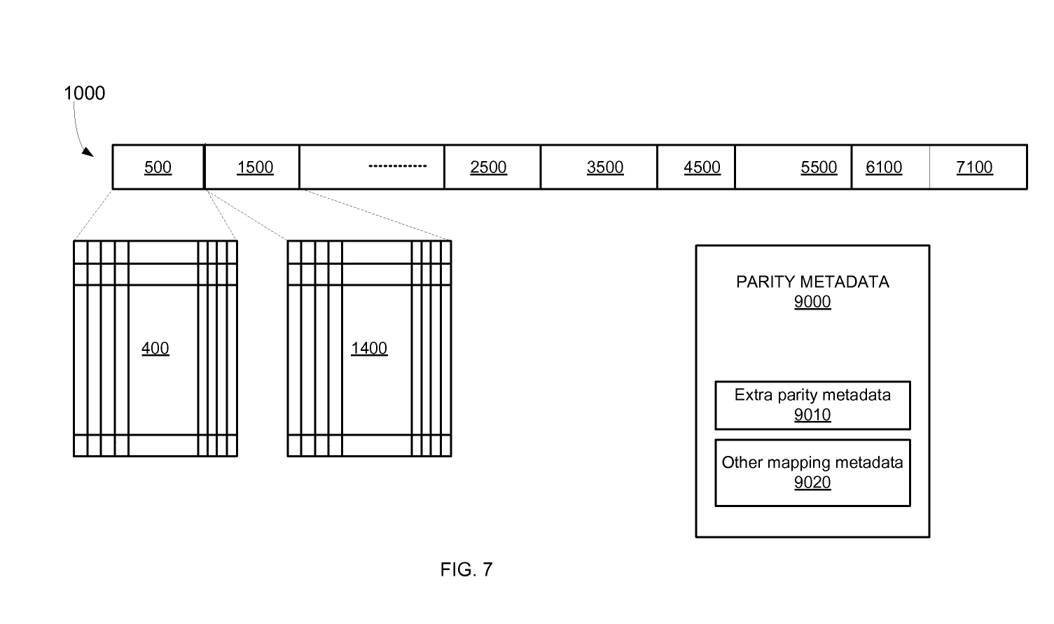

The selection can be made in response to a selection criterion. The selection criterion may be responsive at least one out of (a) priorities of different of data entities protected by different extra parity information, (b) timing of creation of different extra parity information (for example—prioritizing deletion of older extra parity information units), locations of physical addresses allocated for storing different extra parity information, (c) relationships (for example proximity) between physical addresses used for storing different data entities and locations of physical addresses allocated for storing different extra parity information. For example, referring to FIG. 7, physical address range 7100 is more distant from physical address range 2500 than physical address range 6100. Physical address range 2500 is allocated for storing data entities. The difference between these distances may cause the method to treat in a different manner extra parity information stored in physical data ranges 6100 and 7100.

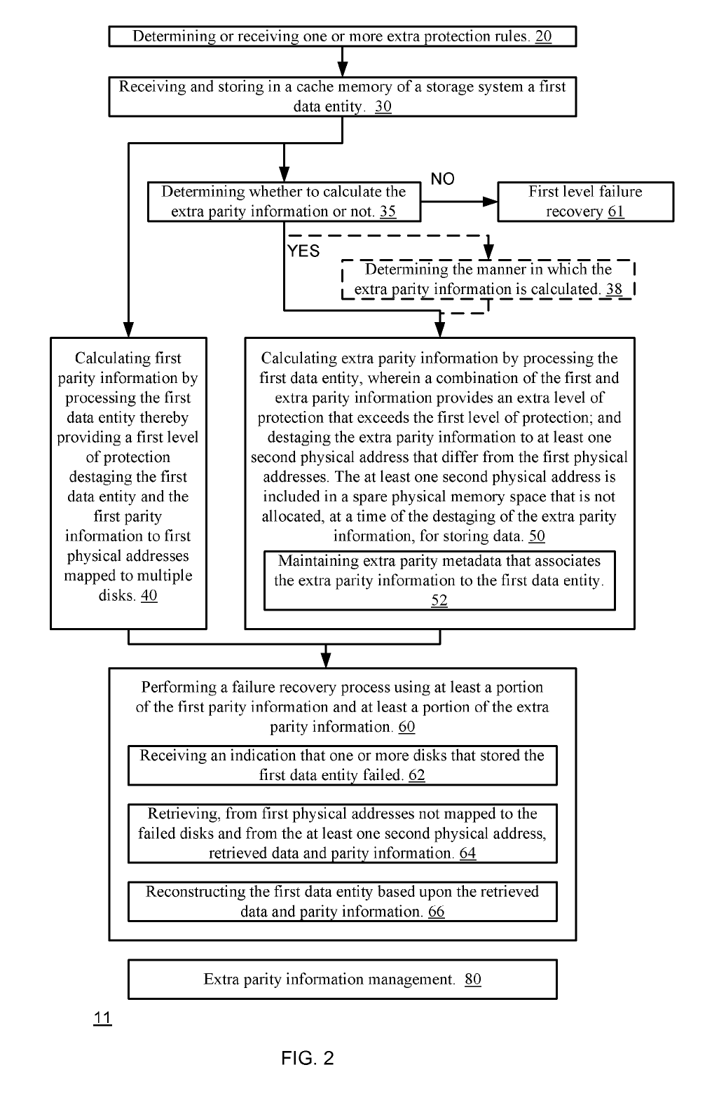

FIG. 2 illustrates method 11 for multi-level protection, according to an embodiment of the invention.

Method 11 differs from method 10 by including stages 35, 38 and 61.

Method 11 starts by stage 20.

Stage 20 may be followed by stage 30 of receiving and storing in a cache memory of a storage system a first data entity.

Stage 30 may be followed by stages 40 and 35.

Stage 40 may include (a) calculating first parity information by processing the first data entity thereby providing a first level of protection and (b) destaging the first data entity and the first parity information to first physical addresses mapped to multiple disks.

Stage 35 may include determining whether to calculate the extra parity information or not.

If it is determined to skip stage 50 then stage 35 is followed by stage 61 of first level failure recovery (executed without using extra parity information).

If is determined not to skip stage 50 then stage 35 may be followed by stage 50.

Alternatively (as shown in dashed boxes and dashed lines)—if is determined not to skip stage 50 then stage 35 may be followed by stage 38 of determining the manner in which the extra parity information is calculated. This stage may include determining the required level of protection to be provided, a disk failure protection process to be applied and the like. Stage 35 and/or stage 38 may be responsive to one or more extra protection rules. Stage 38 is followed by stage 50.

Stage 50 may include (a) calculating extra parity information by processing the first data entity, wherein a combination of the first and extra parity information provides an extra level of protection that exceeds the first level of protection; and (b) destaging the extra parity information to at least one second physical address that differ from the first physical addresses. The at least one second physical address is included in a spare physical memory space that is not allocated, at a time of the destaging of the extra parity information, for storing data.

Stage 50 may be followed by stage 60 preforming a failure recovery process using at least a portion of the first parity information and at least a portion of the extra parity information.

Method 12 may also include stage 80 of extra parity information management.

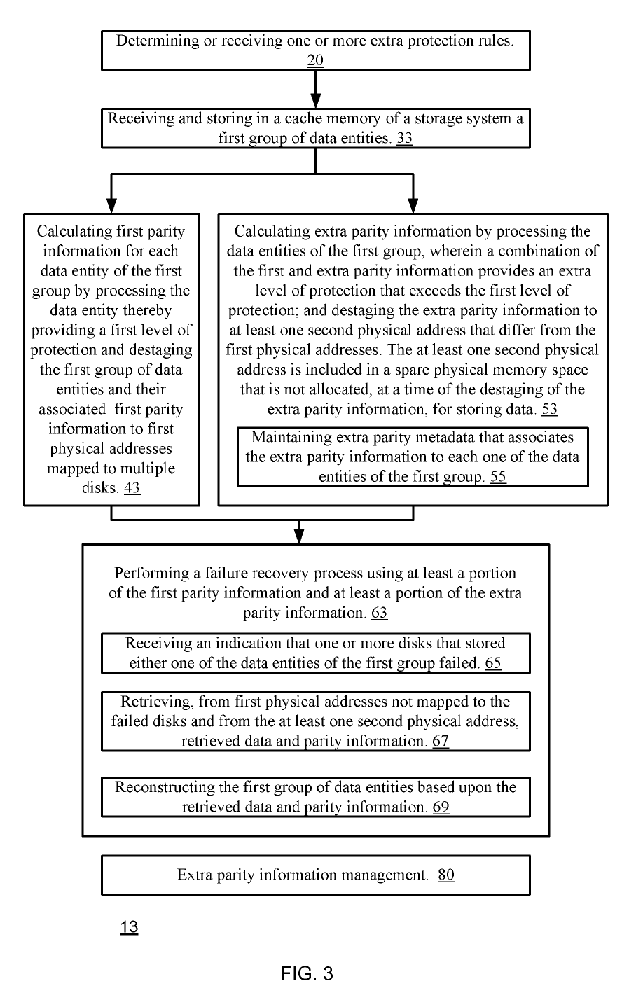

FIG. 3 illustrates method 13 according to an embodiment of the invention.

Method 13 starts by stage 20.

Stage 20 may include determining or receiving one or more extra protection rules.

Stage 20 may be followed by stage 33 of receiving and storing in a cache memory of a storage system a first group of data entities.

Stage 33 may be followed by stages 43 and 53.

Stage 43 may include (a) calculating first parity information for each data entity of the first group by processing the data entity thereby providing a first level of protection and (b) destaging the first group of data entities and their associated first parity information to first physical addresses mapped to multiple disks.

Stage 53 may include (a) calculating extra parity information by processing the data entities of the first group, wherein a combination of the first and extra parity information provides an extra level of protection that exceeds the first level of protection; and (b) destaging the extra parity information to at least one second physical address that differ from the first physical addresses. The at least one second physical address is included in a spare physical memory space that is not allocated, at a time of the destaging of the extra parity information, for storing data.

It is noted that method 13 may include a stage (not shown) of determining whether to calculate the extra parity information or not and skipping stage 53 if determining not to calculate the extra parity information and performing first level failure recovery.

Additionally or alternatively, method 13 may include a stage (now shown) of determining the manner in which the extra parity information is calculated—the required level of protection to be provided, a disk failure protection process to be applied and the like. At least one of these stages may be responsive to one or more extra protection rules. The execution of these stages may result in treating different data entities of the first group in the same manner or in different manners.

Stage 43 may include applying a first protection process. Stage 53 may include applying a second protection process that differs from the first protection process.

The different protection processes may be compliant to different RAID levels, may differ from each other by the number of parity units they provide, may differ by a selection of data units to be used for calculating each parity unit, and the like.

Stage 53 may include maintaining (55) extra parity metadata (see for example extra parity metadata 9010 of FIG. 7) that associates the extra parity information to each one of the data entities of the first group. The extra parity metadata may be included in a same data structure that includes mapping information about the location of the first data entity and the first parity information (see for example parity metadata 9000 of FIG. 7 that includes extra parity metadata 9010 and other parity metadata 9020) or be included in a separate data structure.

Stage 53 may be followed by stage 63 preforming a failure recovery process using at least a portion of the first parity information and at least a portion of the extra parity information.

Stage 63 may include stage 65 of receiving an indication that one or more disks that stored either one of the data entities of the first group failed, stage 67 of retrieving, from first physical addresses not mapped to the failed disks and from the at least one second physical address, retrieved data and parity information, and stage 69 of reconstructing the first group of data entities based upon the retrieved data and parity information.

Method 13 may also include stage 80 of extra parity information management. This stage of extra parity information management may involve deleting all or some of the extra parity information. The deletion may be responsive to a parameter of the storage system, and/or a parameter of data that is being protected and/or a parameter of the extra parity information.

The following example illustrates an execution of method 13 under the following (non-limiting) assumptions:
A. The first protection level is a RAID 6 protection level.
B. Each data entity includes fourteen data units.
C. Each data entity and its two parity units form a stripe.
D. A first group of data entities includes two hundred and fifty six data entities.
E. A hybrid group is formed and it includes two hundred and fifty six stripes (a stripe per row) and sixteen columns—wherein the parity units are evenly distributed between different columns of the hybrid group.
F. Each column of the hybrid group is sequentially written to a disk, wherein different columns are written to different disks.
G. The columns are distributed between disks of different disk units (such as disk enclosures) so that up to two columns are written to disks of the same disk enclosure.

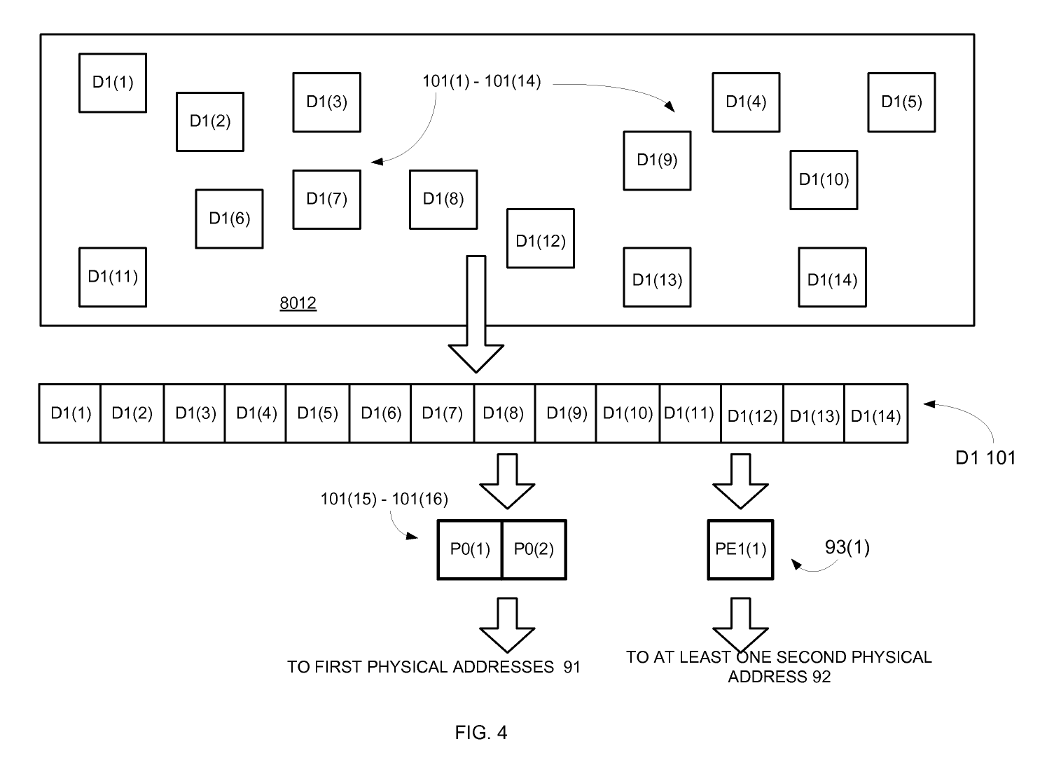

FIG. 4 illustrates fourteen data units D1(1)-D1(14) that form data entity D1 101 and are retrieved from a cache memory 8012 and processed to provide (i) two parity units P0(1) and P0(2) 101(15) and 101(16) (corresponding to RAID 6 level) and (ii) an extra parity unit PE1(1) 93(1). More than a single extra parity unit may be calculated.

The two parity units P0(1) and P0(2) 101(15) and 101(16) may be sent to first physical addresses 91 while the extra parity unit PE1(1) 91(1) may be sent to at least one second physical address.

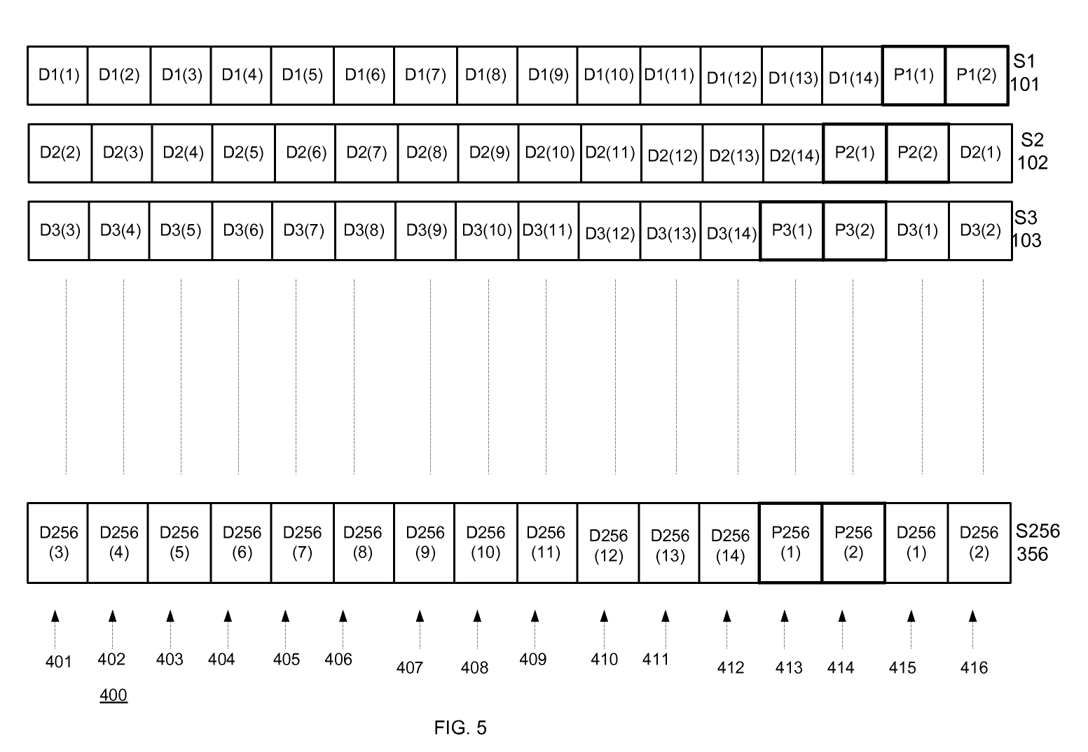

FIG. 5 illustrates a hybrid group 400 according to an embodiment of the invention. It includes sixteen columns 401-416 and two hundred and fifty six stripes S1-S256 101-356, each stripe includes fourteen data units and two parity units. The two parity units are evenly distributed between columns 401-416.

The data units include, for example D1(1)-D1(14) of S1 101, D2(1)-D2(14) of S2 102, D3(1)-D3(14) of S3 103 and D256(1)-D256(14) of S256 356.

The two parity units include, for example, P1(1)-P1(2) of S1 101, P2(1)-P2(2) of S2 102, P3(1)-P3(2) of S3 103 and P256(1)-P256(2) of S256 356.

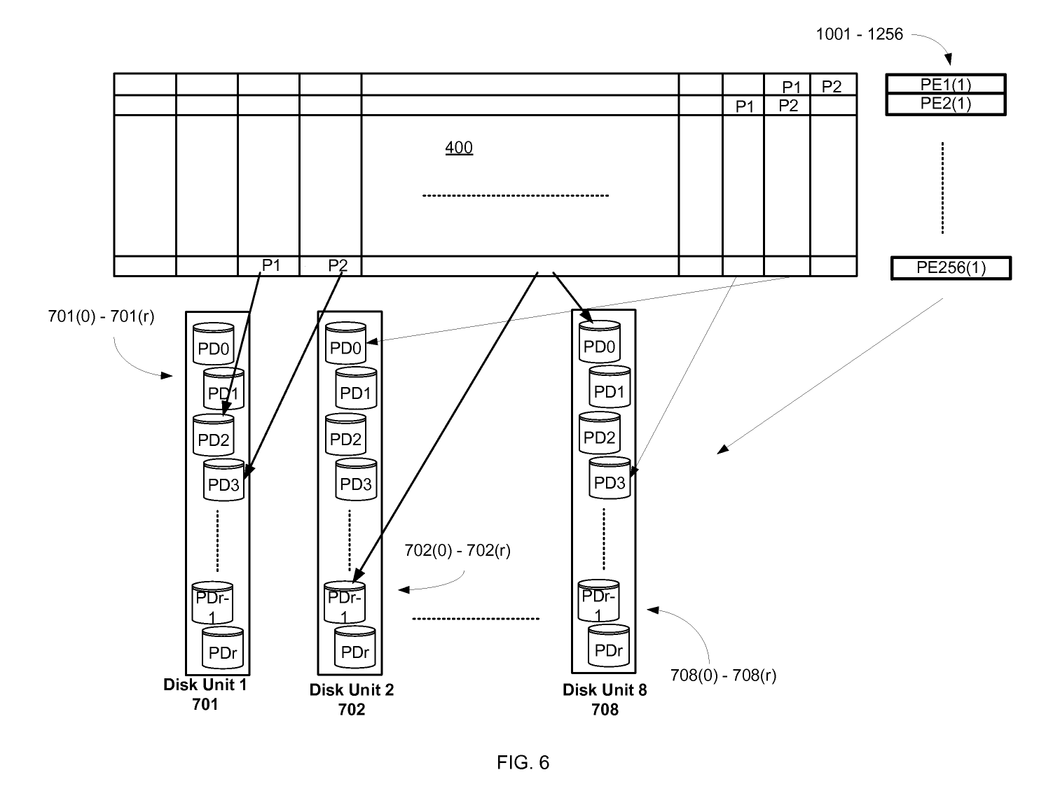

FIG. 6 illustrate the writing of hybrid group 400 to disks of eight disk units 701-708, each column of hybrid group 400 is destaged to a single disk and up to two columns are destaged to disks of the same disk unit.

Each disk unit is shown as including multiple (r+1) disks—disks 701(0)-701(r) of disk unit 701, disks 702(0)-702(r) of disk unit 702, and disks 708(0)-708(r) of disk unit 708.

Entries in these disks that are used to store the different columns of the hybrid group are mapped to first physical addresses.

FIG. 6 also shows two hundred and fifty size extra parity units PE1(1)-PE256(1) 1001-1256 that are written to second physical addresses that may be mapped to the disks of disk units 701-708 or within other disks (not shown).

FIG. 7 illustrates an allocation of a physical memory space 1000 to hybrid groups and to extra parity information according to an embodiment of the invention.

Physical memory space 1000 is shown as including:
A. First physical address ranges 500 and 1500 that store hybrid groups 400 and 1400 respectively.
B. Additional address ranges 2500, 3500, 4500 and 5500 that are allocated for storing hybrid groups (but do not currently store hybrid groups).
C. A free storage space that includes physical address ranges 6100 and 7100 that are not allocated for storing hybrid groups.

It is noted that while FIG. 7 illustrates that the free storage space starts only after the memory space allocated for storing hybrid groups ends—this is not necessarily so.

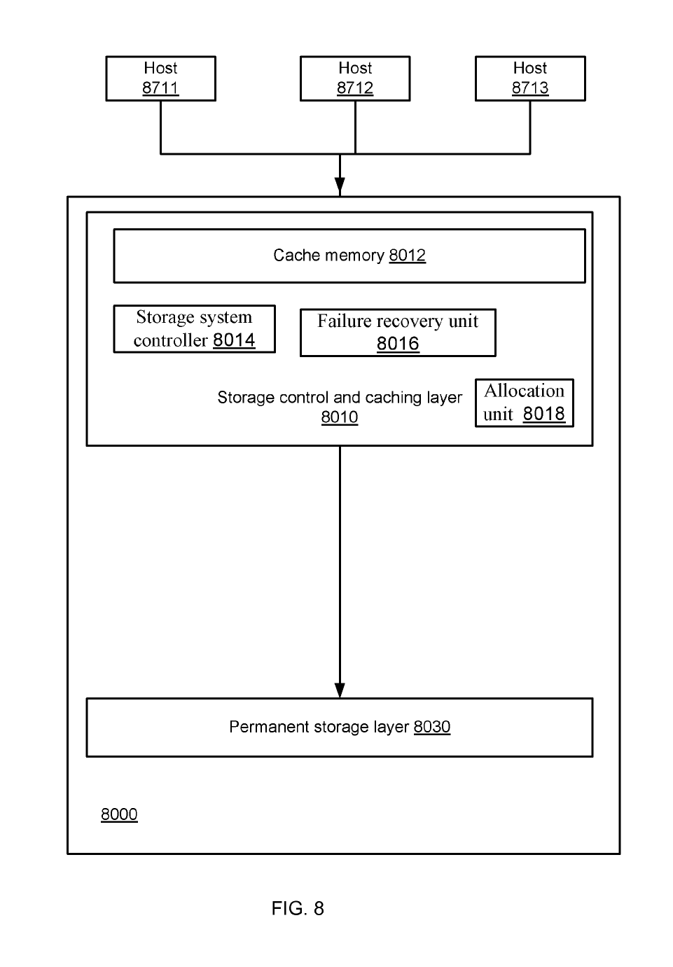

FIG. 8 illustrates a storage system 8000 according to an embodiment of the invention.

Storage 8000 is a mass storage system and includes may store multiple terabytes—even one petabyte and more. It may include permanent storage layer 8030 and storage control and caching layer 8010.

System 8000 may be accessed by multiple computerized systems such as host computers (denoted “host”) 8711, 8712 and 8713 that are coupled to storage system 8000 over a network (not shown). The computerized systems 8711-8713 can read data from the storage system 8000 and/or write data to the storage system 8000.

The permanent storage layer 8030 may include disks such as those illustrated in FIG. 6.

Storage control and caching layer 8010 includes a cache memory 8012, a storage system controller 8014, a failure recovery unit 8016 and an allocation unit 8018.

The storage system controller 8014 controls the operation of different units of the storage system 8000.

Storage system 8000 may execute any one of methods 10, 11 and 13.

Cache memory 8012 caches data entities before they are destaged.

Failure recovery unit 8016 is arranged to calculate parity information (including extra parity information).

Allocation unit 8018 is arranged to allocate physical addresses to data entities and to parity information (including extra parity information). It can also manage the utilization of the free memory space and determine when to delete extra parity information.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for multi-level disk failure protection, the method comprises:
calculating first parity information by processing a first data entity that is cached in a cache memory of a storage system thereby providing a first level of disk failure protection;
destaging the first data entity and the first parity information to first physical addresses mapped to multiple disks;
calculating extra parity information by processing the first data entity, wherein a combination of the first and extra parity information provides an extra level of disk failure protection that exceeds the first level of disk failure protection; and
destaging the extra parity information to at least one second physical address that differ from the first physical addresses, the at least one second physical address are included in a spare physical memory space that is not allocated, at a time of the destaging of the extra parity information, for storing data.

2. The method according to 1 wherein the calculating of the first parity information comprises applying a first disk failure protection process and wherein the calculating of the extra parity information comprises applying a second disk failure protection process that differs from the first disk failure process.

3. The method according to claim 1 wherein a number of parity units included in the extra parity information differs from a number of parity units included in the first parity information.

4. The method according to claim 1 wherein the first level of disk failure protection is a minimal acceptable level of disk failure protection.

5. The method according to claim 1 comprising maintaining parity metadata that associates the extra parity information to the first data entity.

6. The method according to claim 1 comprising determining the extra level of protection in response to an availability of physical addresses for storing extra parity units.

7. The method according to claim 1 comprising determining the extra level of protection in response to a priority of the first data entity.

8. The method according to claim 1 comprising deleting the extra parity information while maintaining the first data entity and the first parity information.

9. The method according to claim 1 comprising determining not to calculate the extra parity information in response to a parameter selected out of (a) a parameter of the storage system and (b) a parameter of the first data entity.

10. The method according to claim 1 comprising calculating and destaging multiple extra parity information for multiple data entities; calculating and destaging multiple first parity information for the multiple data entities; selecting, in response to a selection criterion, a selected extra parity information to be deleted; and deleting the selected extra parity information; wherein the multiple data entities comprises the first data entity.

11. The method according to claim 10 wherein the selection criterion is responsive to priorities of different of data entities protected by different extra parity information.

12. The method according to claim 10 wherein the selection criterion is responsive to timing of creation of different extra parity information.

13. The method according to claim 10 wherein the selection criterion is responsive to locations of physical addresses allocated for storing different extra parity information.

14. The method according to claim 10 wherein the selection criterion is responsive to relationships between physical addresses used for storing different data entities and locations of physical addresses allocated for storing different extra parity information.

15. The method according to claim 10 wherein the multiple first parity information and the multiple data entities comprise a hybrid group, wherein each row of the hybrid group comprises a data entity and first parity information of the data entity; wherein first parity information of different rows are distributed among different columns of the hybrid group; wherein each column of the hybrid group is sequentially destaged to a single disk.

16. The method according to claim 15 wherein the multiple first parity information and the multiple data entities comprise multiple hybrid groups; wherein the multiple extra parity information are stored in the spare physical memory space, wherein the spare physical memory space is not allocated, at a time of the destaging of either one of the destaging of the multiple extra parity information, for storing hybrid groups.

17. The method according to claim 1 further comprising: receiving an indication that one or more disks that included the first physical addresses failed; retrieving, from the first physical addresses and from the at least one second physical address, retrieved data and parity information; and reconstructing the first data entity based upon the retrieved data and parity information.

18. A non-transitory computer readable medium that stores instructions that once executed by a computer cause the computer to perform the stages of: calculating first parity information by processing a first data entity that is cached in a cache memory of a storage system thereby providing a first level of disk failure protection; destaging the first data entity and the first parity information to first physical addresses mapped to multiple disks; calculating extra parity information by processing the first data entity, wherein a combination of the first and extra parity information provides an extra level of disk failure protection that exceeds the first level of disk failure protection; and destaging the extra parity information to at least one second physical address that differ from the first physical addresses, the at least one second physical address are included in a spare physical memory space that is not allocated, at a time of the destaging of the extra parity information, for storing data

19. A storage system comprising a failure recovery module that is arranged to calculate first parity information by processing a first data entity that is cached in a cache memory of a storage system thereby providing a first level of disk failure protection; a storage system controller that is arranged to destage the first data entity and the first parity information to first physical addresses mapped to multiple disks of the storage system; wherein the failure recovery module is further arranged to calculate extra parity information by processing the first data entity, wherein a combination of the first and extra parity information provides an extra level of disk failure protection that exceeds the first level of disk failure protection; and wherein the storage system controller is further arranged to destage the extra parity information to at least one second physical address that differ from the first physical addresses, the at least one second physical address are included in a spare physical memory space that is not allocated, at a time of the destaging of the extra parity information, for storing data.
